(19) United States
(12) Patent Application Publication
(10) Pub. No.: US 2002/0118300 A1
(43) Pub. Date: Aug. 29, 2002

(54) Media editing method and software therefor

(76) Inventors: Guy Alexander Tom Middleton, Harrogate (GB); Christopher Walker, Harrogate (GB)

Correspondence Address: John V. Moriarty, Woodard, Emhardt, Naughton, Moriarty and McNett, Bank One Center/Tower, 111 Monument Circle, Suite 3700, Indianapolis, IN, 46204-5137, US

(21) Appl. No.: 09/846,840

(22) Filed: May 1, 2001

(30) Foreign Application Priority Data
Feb. 8, 2001 (GB) 0103130.1

(51) Int. Cl. H04N 5/50

(52) U.S. Cl. 348/569

(57) ABSTRACT

Media Editing Method and Software therefor A method of viewing a sequence of media clips consisting essentially of a plurality of computer files and software for achieving the method are disclosed. A user of a local machine connected to a computer network, which may be a local area network (LAN), wide area network (WAN) or the wider internet uses a browser program to make a connection with a primary server on that network. The primary server hosts a database application which the user can update with media clip file location information, sequencing information, and play variables oassociated with those media clips. The media clip file locations may be locally stored on the primary server, or on any other computer connected to the network allowing the user access to files thereon. The primary server also runs software capable of decoding said media clip files and consecutively playing said files or portions thereof, and on request from the local machine, such software consecutively retrieves relevant portions of the identified media clip files in the correct sequence and decodes same for play based on the relevant information in the database. The played media clip files are thus retrieved and played on the primary server computer while the program of the invention is loaded on the local machine, typically within a browser-type program which allows both the database to be updated and the played portions of the media clip files to be viewed.

This invention relates to a method of editing and sequencing different media clips together and to software adapted to carry out the method.

The reader may be aware of many software packages which are currently available which facilitate the editing and sequencing of media clips. Such media clips are to be considered as binary files of different types, such as WAV, AVI, MPEG and the like which are commonly used to store media information such as moving images, sound, combined sound and video, and pictures and which are coded according to standard or proprietary formats which are available freely or by payment of licence fees.

The standardised formats are programmatically embedded into applications which are used to both create, store, and open such files for viewing and/or listening. An example of such an application is the Windows® Media Player which can recognise and decode a number of different standard file formats, and thus play back a number of different types of media clip. This Media player is however intended as an essentially simple program for the playback or viewing of video and/or sound clips individually and there is no facility for combining two or more such media clips in a flexible manner.

Modern and commercially available editing suites range from those which are intended only for desktop or home use to allow a relative novice editor to create a programme having a length of the order of a minute or less having and relatively few media clips spliced together, to those which are intended for use by commercial broadcasters where entire programmes for broadcast may be compiled including large media clips or clips which may be derived from a wide number of sources and thus be encoded according to a large number of different standard formats.

Typically however, editing packages are intended for use on a single workstation and whether this be a high end workstation in the case of editing for commercial broadcast purposes or low end workstation for use at home, the utility of the package is limited by the requirement for local or network access to files containing the media clips.

For instance, when it is desired to create a new programme incorporating a number of different media clips, the editing application suite will request the user to load these files from location either on a network virtual drive or a local hard drive. The reader will immediately recognise the requirement for large physical memory (RAM) in cases where the files containing the media clips are large. The editing application will then permit the user through its graphical user interface to arrange, splice, edit and playback the various media clips stored in memory, and furthermore may also allow the user to adjust characteristics of each or all the media clips, such as brightness, contrast, playback speed, sound level, pitch, and the like. Additionally, the user may select the duration of the playback of each media clip so that the clip is played from the start for a shorter time than the length of the entire clip or alternatively the user may select a segment by providing a start time and end time relative to the beginning and end of the clip.

After a user has selected the segments of each of the clips loaded into the memory, and furthermore adjusted all their characteristics so that the programme of clips is played back apparently seamlessly and without significant discontinuities, the user can command the editing package to render all the relevant information contained within each of the media clips into a single file, which is in itself effectively a media clip. As readers familiar with graphical rendering will be aware, the rendering process can in some circumstances take many hours or even days depending on the sizes and relative resolutions of the various clips incorporated in a particular programme.

More recently, Microsoft® have introduced software which allows files containing certain media clips to be viewed without any requirement to load the entire file into physical memory, and indeed this software allows files and portions thereof to be viewed from their physical locations without needing to be copied in their entirety from their physical locations to the local hard disk of the computer on which such files are being viewed. This software allows for previously unprecedented flexibility in the viewing of media clips.

Although the concept of “streaming” media clips is currently well known, and indeed many internet sites are designed specifically for this purpose, the streaming of the clip essentially amounts to viewing the media clip represented by the streamed file as it is downloaded from a particular site as opposed to having to wait for the entire file to download before viewing. Accordingly, the user wishing to view the streamed clip must execute an application locally which can recognise the file containing the media clip to be streamed. Henceforth the viewing of the media clip, often achieved in an internet browser program having a suitable plug-in component loaded therein, is limited by the bandwidth of the connection of the particular user. More simply, the user is still required to download the file to be viewed, and although the viewing occurs in real time during download, the quality of the viewed clip is often poor as a result of the significant compression which is required to enable the file to be downloaded in a reasonable time, and furthermore the motion of video images viewed in the clip is often discontinuous as downloaded information is required to be buffered in the playback process.

A yet further disadvantage of such streaming is that the stream of data from a particular internet or ftp site is dependent on a permanent connection while the streaming is in progress. Any interruption in this connection can often cause the local machine to crash as the operating system can be rendered unstable when only receiving only part of a streamed file.

Accordingly, it is an object of this invention to provide a means of constructing, editing, viewing, storing and recalling a sequence or programme consisting of a plurality of files representing media clips wherein there is no requirement on the local user to download or copy such files from their physical location either prior to viewing, or by streaming the files into the local machine.

It is a further object of the invention to provide a means for allowing a user of a site to create his own programme consisting of a plurality of different files stored in a number of physically disparate locations on any computer network.

It is a yet further object of this invention to provide a means of seamlessly viewing a compiled programme or sequence of media clips from any computer connected to a computer network and having a browser loaded thereon.

It is a yet further object of the invention to provide a means of viewing a number of media clips consecutively in a seamless manner without any requirement for rendering all the files representing such media clips into a single file.

According to a first aspect of the invention there is provided a method of viewing a sequence of media clips consisting essentially of a plurality of computer files, wherein a user of a local machine connected to a computer network having a one or more server computers connected thereto on which are physically located said files and software capable of decoding said files and consecutively playing said files or portions thereof, wherein said user creates a database stored on said server computer consisting of a play list of said files in a particular order, said user further specifying a number of play variables relevant to each file played in the sequence, characterised in that on receiving a play command from the local machine, the software capable of decoding said files retrieves the physical location of the files in the sequence and the play variables relevant to each particular file in sequence and commences play thereof, said local machine having a viewer thereon by which the played files in the sequence can be viewed.

Preferably the addition, amendment, and deletion of files from the play list and of play variables relevant to each file, and the viewing of the played sequence of files is conducted through a browser program having a suitable plug-in component loaded thereon allowing media clips to be viewed or heard.

Preferably, the user is required to enter user specific information such as a user identifier and password to allow the server computer to identify said user and establish relevant access rights to said server computer and/or the various files physically stored thereon or elsewhere.

Most preferably the database ensures that the data relevant to one or more sequences created by a user is linked to a user identifier to ensure that only sequences created by that user are accessible to that user after entering said user specific information.

In a further aspect of the invention there is provided a computer program for execution on a local machine and for viewing a sequence of media clips, said local machine being connected to a computer network having a one or more server computers connected thereto on which are physically located a plurality of files containing media clips and software capable of decoding said files and consecutively playing said media clips or portions thereof, said program permitting communication with a database located on said server computer containing information describing a play list of said files in a particular order and further specifying a number of play variables relevant to each file played in the sequence, characterised in that said program retrieves the information describing said play list and the play variables from said database and communicates said information to the software capable of decoding the files and playing the media clips which subsequently loads said files or portions thereof consecutively and plays the media clips therefrom, said program further comprising viewing means for allowing a user to view the sequence of files played by the software capable of decoding.

The fundamental difference between the present invention and currently available programs and methods is that it is the software disposed on the server computer which effects the laborious tasks of file reading and playing the media clip or a portion thereof, whereas the program executing locally only acts as a viewer for the played information. In this manner, the bandwidth overhead involved in downloading individual files to the local machine, as is current practice, is significantly reduced and thus seamless sequences of many media clips can be viewed substantially continuously on said local machine.

A specific embodiment of the invention will now be described by way of example only with reference to the accompanying drawings wherein:

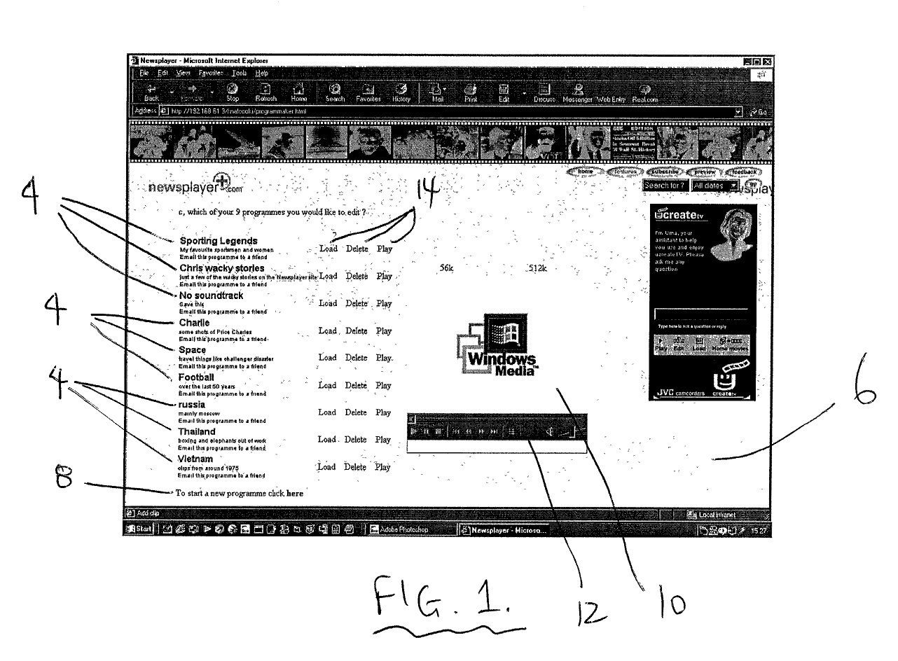

FIGS. 1, 2, 3, and 4 show screen shots of the various web pages presented to a user of a client machine wishing to compile a new programme or having already compiled some pre-existing programmes.

The program of the present invention typically operates in one of the many available internet browsers loaded onto a local machine connected to a computer network. This network may be a simple LAN, an intranetwork, a WAN or more generally the internet as a whole as this provides the local user with access to a vast number of media clips.

On starting the browser program and downloading the particular page containing the program (which may be programmed in any of a number of different languages such as HTML, Javascript, VBScript, or the like), the user may be presented with a login screen requiring entry of user specific details such as a password and username. Once entered, a connection to a database on the server computer is established. The database will enforce relevant security provisions and in general, only tables within the database created by a particular user will be readable or updateable by that user.

An example of a typical web page presented to a user for view after login details have been entered and processed is shown in FIG. 1. In this Figure, a list of programmes 4 which the user compiled in a previous session are shown within the page 6 displayed typically in a modern browser program, such Microsoft® Internet Explorer or Netscape Navigator. The titles of these programmes may be chosen by the user as desired. In this particular embodiment, a media viewing plug-in 10 is also embedded within the page 6, in this case Windows® Media Player as shown, and this plug-in component may optionally be provided with a command tool bar 12. Adjacent each programme name 4 are provided a collection of links 14 which respectively allow a user to load, play or delete the entire programme. Other suitable commands useful in the manipulation of the entire programmes compiled by the user may also be included.

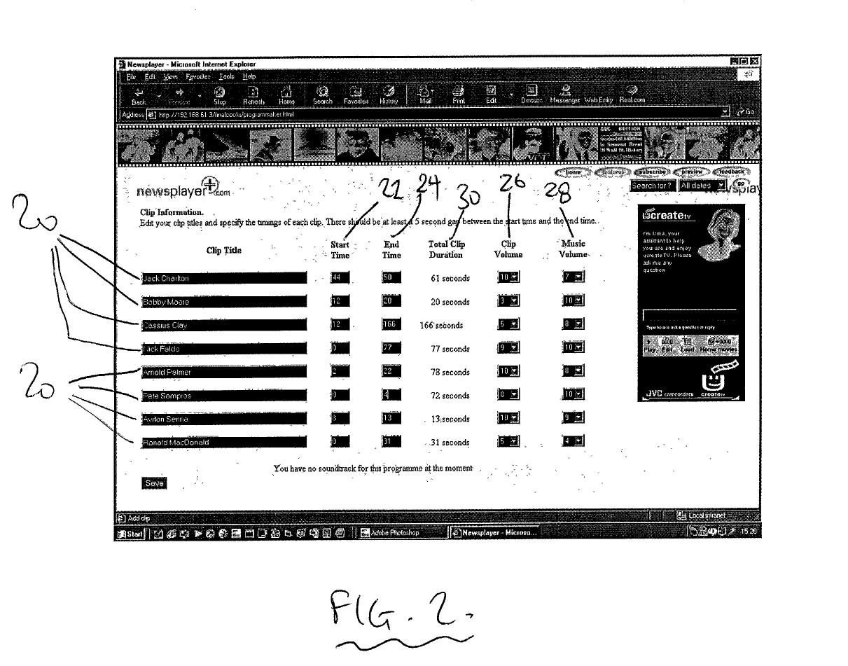

Within the web page 6, a link 8 is provided which on clicking allows the user to view a programme clip information page such as that shown in FIG. 2. In this Figure, the user has compiled a list of individual clips having titles 20, the files for which may be stored in a variety of different locations, for play in a particular sequence as defined by the user.

The user has additionally entered different types of information, such as the physical location of a file containing a media clip, the start 22 and end times 24 of the clip, the clip volume 26 and music volume 28 and it is to be pointed out that the location can be either locally on the server computer or on another computer connect to the computer network, whether this be a LAN, a WAN or the internet. Indeed, it is possible for a user to specify the location of a file containing a media clip as being an ftp address. The total clip duration 30 is calculated by the computer depending on the chosen start and end times.

The program one the one hand therefore acts as a simple front end for a database and allows for records to be added, amended and deleted. Each record in the database or “slot” contains details of the physical location of the clip together with a number of play variables such as the start and end times or duration for which the clip is to be played, the brightness, contrast or other picture level setting, speed of playback, sound levels, descriptions and titular information, etc.

This information is entered for each media clip which forms part of the sequence and listed on screen. Once all the relevant information has been entered on the HTML or Javascript form presented to the user on the local machine, a send command transfers all the information to said database. Those skilled in the art of database front end programming will appreciate that a number of different programming techniques may be used.

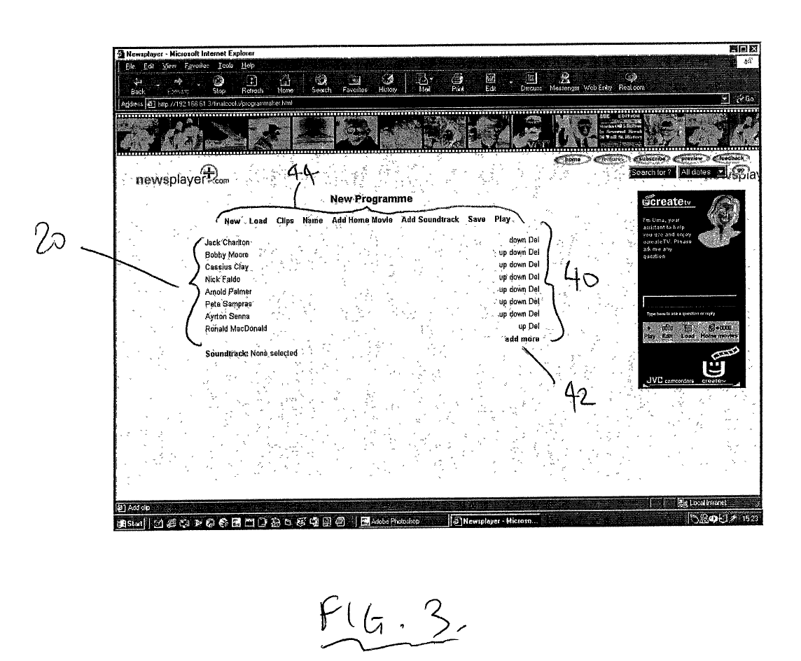

In one embodiment, the clip information presented for display in FIG. 2 can be altered using a further web page presented to the user as shown in FIG. 3. In this Figure, the various clips 20 are listed in an order originally defined by the user and stored in the database, and a series of links 40 allow the user to alter the position of each clip either up or down within the sequence or to delete a particular clip from the sequence. An additional link 42 allows the user to add a further clip into the sequence, should this be desired. Also within the web page of FIG. 3, there is provided a menu list 44 in which a variety of clip—and programme specific commands are available.

In accordance with the invention, the program also comprises a viewer and a play command button which communicates the play list information and play variables from the database to software running on said server which controls the retrieval and playback of each file containing a clip in the play list.

This software can be controlled using relatively simple commands from any local machine on the network with authorised access without any requirement to download the individual files containing the media clips onto said local machine. Indeed the browser on the local machine only needs to load the relevant internet page comprising the program and viewer to be able to view the sequence of played media clips.

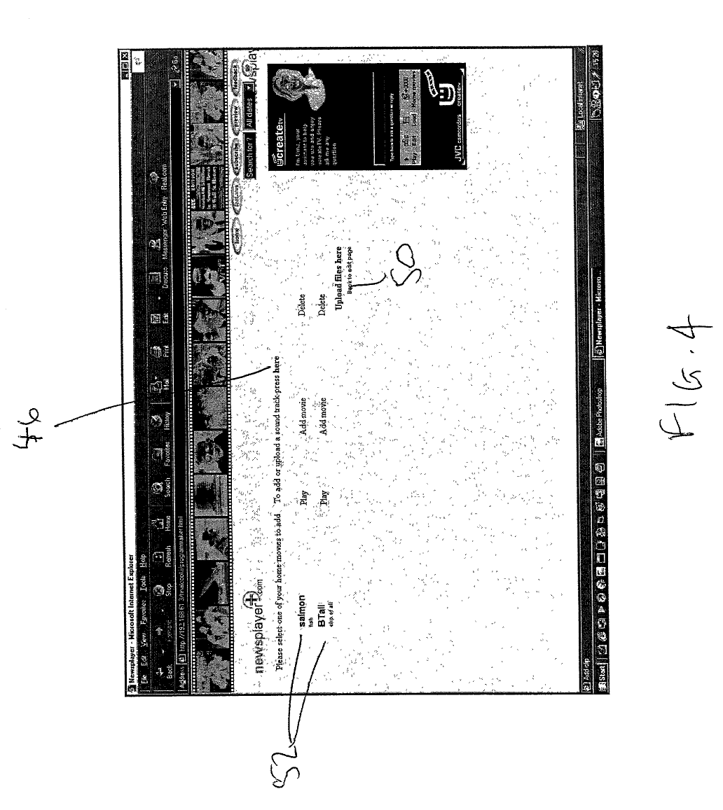

In FIG. 4, further possible features of the invention are demonstrated; for instance a soundtrack may be added to the programme and played simultaneously using a link 46. The screen also offers the possibility for users to upload their own files at 50, and two previously uploaded clips 52 are shown on the screen for selection.

A possible example application for the invention may be in the educational market where a teacher could compile a playlist of factual media clips on a particular subject for viewing by a class of pupils.

In terms of the various method steps which might be required in the implementation of the method of the invention, the following are exemplary:

1. A variable array is set up to hold the attributes of each segment of the programme. We refer to these as Slots variables.

2. In whichever way video clips are presented to the user via a site, a button allows the user to ‘add’ the attributes of the clip into the first free Slot.

3. A list of clips in the current ‘programme’ can be displayed by displaying the contents of the filled Slots.

4. By using an ‘up’ button by a clip, the contents of the relevant Slot are swapped with the one above, thus moving the clip up and the one above down.

5. By using a ‘down’ button by a clip, the contents of that Slot are swapped with the one below.

6. By using a ‘delete’ button by a clip, the contents of that Slot are replaced by the contents of the Slot below, continuing until all the last filled slot is moved and that Slot if cleared as there are now 1 less clips in the programme.

7. By using input boxes or a graphical mechanism, the start and end times of each clip in the programme can be selected. Checking occurs to make sure they are valid.

8. By using input boxes the original description of the clip can be changed

9. By using input boxes a title and description can be given to the programme.

10. A ‘save’ button stores the contents of the Slots variable array into a database on the site's server, usually linked to the user identifier.

11. A ‘load’ button loads an array from the database.

12. A ‘play’ button starts the playing of each clip in each used Slot, starting at the start time, ending at the end time, displaying the description by the video window. This continues until all the clips have been played.

13. By having a stock of introduction and end sequences that the user may ‘load’ into a Slot, the user can add elements to provide a conventional programme look and feel.

14. The referenced location of a clip stored in the Slot attributes can be anywhere on the network, Internet or local PC. Thus home movies can be mixed with footage from multiple web sites.

15. Input boxes allow the control of the volume level of the original sound track to each clip.

16. Input boxes allow the control of the volume level of a referenced soundtrack to accompany the programme. The sound may be referenced from anywhere on the network, Internet or local PC.

17. By emailing the URL containing the server location, the programme ID and a password if necessary to control access, the recipient of the email can click on the URL in the email and watch the programme instantly. On clicking the URL the server loads the programme information into the Slot array and plays the contents.

1. A method of viewing a sequence of media clips consisting essentially of a plurality of computer files, wherein a user of a local machine connected to a computer network having a one or more server computers connected thereto on which are physically located said files, one of said servers being the one with which the local machine primarily communicates having executing thereon software capable of decoding said files and consecutively playing said files or portions thereof, wherein said user creates a database or a set of records within a database stored on said one server computer consisting of a play list of said files in a particular order, said user further specifying a number of play variables relevant to each file played in the sequence, characterised in that on receiving a play command from the local machine, the software capable of decoding said files retrieves the physical location of the files in the sequence and the play variables relevant to each particular file in sequence and commences play thereof, said local machine having a viewer thereon by which the played files in the sequence can be viewed.

2. A method according to claim 1 wherein addition, amendment, and deletion of files from the play list and of play variables relevant to each file, and the viewing of the played sequence of files is conducted through a browser program having a suitable plug-in component loaded thereon allowing media clips to be viewed or heard.

3. A method according to claim 2 wherein the user is required to enter user specific information such as a user identifier and password to allow the server computer to identify said user and establish relevant access rights to said server computer and/or the various files physically stored thereon or elsewhere, said user specific information being used to retrieve information from said database regarding particular files and play variables previously defined by said user.

4. A method according to claim 3 wherein the database ensures that the data relevant to one or more sequences created by a user is linked to a user identifier to ensure that only sequences created by that user are accessible to that user after entering said user specific information.

5. A computer program for execution on a local machine and for viewing a sequence of media clips, said local machine being connected to a computer network having a one or more server computers connected thereto on which are physically located a plurality of files containing media clips, said local machine communicating primarily with one of said servers on which is executing software capable of decoding said files and consecutively playing said media clips or portions thereof, said program permitting communication with a database located on said server computer containing information describing a play list of said files in a particular order and further specifying a number of play variables relevant to each file played in the sequence, characterised in that said program retrieves the information describing said play list and the play variables from said database and communicates said information to the software capable of decoding the files and playing the media clips which subsequently loads said files or portions thereof consecutively and plays the media clips therefrom, said program further comprising viewing means for allowing a user to view the sequence of files played by the software capable of decoding.
